(19) United States
(12) Patent Application Publication
(10) Pub. No.: US 2015/0325133 A1
(43) Pub. Date: Nov. 12, 2015

(54) INTELLIGENT DELIVERY OF EDUCATIONAL RESOURCES

(71) Applicant: Knowledge Diffusion Inc., Cambridge, MD (US)

(72) Inventors: Shiv Gaglani, Melbourne Beach, FL (US); Ryan Haynes, Calhoun, LA (US)

(21) Appl. No.: 14/705,634

(22) Filed: May 6, 2015

Related U.S. Application Data
(60) Provisional application No. 61/989,225, filed on May 6, 2014.

(51) Int. Cl. G09B 7/00; G09B 5/06

(52) U.S. Cl. CPC G09B 7/00; G09B 5/06

(57) ABSTRACT

A computer-implemented method for generating educational materials for a user includes a computer receiving a user data item representative of educational interests of the user. The computer extracts a plurality of words from the user data item, classifies the user data item into a related knowledge domain, and determines a frequency score for each of the plurality of words. The computer uses frequency score determined for each of the plurality of words to select a plurality of educational material items associated with the related knowledge domain. Next, the computer determines a similarity score for each of the plurality of educational material items indicative of each respective educational material item's similarity to the user data item. The computer uses the similarity score for each of the plurality of educational material items to select a subset of the plurality of educational material items. The computer presents the subset of the plurality of educational material items in a graphical user interface.

### CROSS-REFERENCE TO RELATED APPLICATIONS

This application claims priority to U.S. provisional application Ser. No. 61/989,224 filed May 6, 2014, which is incorporated herein by reference in its entirety.

### TECHNICAL FIELD

The present invention relates generally to methods, systems, and apparatuses for delivering educational resources to a user based on curriculum materials and other information from, for example, publicly available sources and publishing partners. The disclosed methods, systems, and apparatuses may be applied to, for example, generate a list of questions for a user or to identify relevant articles or other material for the user.

### BACKGROUND

Many modern websites employ machine learning techniques and other sophisticated algorithms to enhance the experience of their users. For example, some websites analyze user personal information, behaviors, and habits, to provide recommendations for goods and services. Moreover, some websites also utilize collective knowledge gleaned from a population of users to measure the overall success of particular content offerings. For example, in the context of web video, data associated with viewers can be used to determined information such as the gender, age, and income breakdown of viewer.

In contrast to customization found on the web, information in educational settings has traditionally been disseminated using a “one size fits all” paradigm. For example, study materials are typically static resources which do not reflect the knowledge of the student. Thus, the material that student understands well may be overemphasized, while the material that the student is less knowledgeable about is underemphasized. Because time and resources may be limited, this inefficiency could result in poor performance on tests. Moreover, there is no way for a student to provide direct feedback regarding the study materials or the student's confidence in his or her knowledge of the material. Accordingly, it is desired to enhance the traditional education model using machine learning and other techniques to allow users to learn in an interactive study environment.

### SUMMARY

Embodiments of the present invention address and overcome one or more of the above shortcomings and drawbacks, by providing methods, systems, and apparatuses related to the intelligent delivery of educational resources via a mobile or web-based interface.

According to some embodiments, a computer-implemented method for generating educational materials for a user includes a computer receiving a user data item representative of educational interests of the user. The computer extracts a plurality of words from the user data item, classifies the user data item into a related knowledge domain, and determines a frequency score for each of the plurality of words. The computer uses frequency score determined for each of the plurality of words to select a plurality of educational material items associated with the related knowledge domain. Next, the computer determines a similarity score for each of the plurality of educational material items indicative of each respective educational material item's similarity to the user data item. The computer uses the similarity score for each of the plurality of educational material items to select a subset of the plurality of educational material items. The computer presents the subset of the plurality of educational material items in a graphical user interface.

The user data item used in the aforementioned method may vary according to different embodiments of the present invention. For example, in some embodiments, the user data item comprises curriculum materials related to academic courses in which the user is enrolled. In other embodiments, the user data item comprises a video and the plurality of words are extracted from the user data item using closed caption information associated with the video.

In some embodiments of the aforementioned method, prior to extracting the plurality of words from the user data item, the words are tokenized to group related words as entities. In one embodiment where such tokenization is performed, the user data item is classified into the related knowledge domain by selecting knowledge domains and assigning each of the words to one of the knowledge domains. A word count is determined for each of the knowledge domains which corresponds to the number of assigned words from the words. The knowledge domain which has the maximum word count is then designated as the related knowledge domain. In one embodiment, the user data item is presented simultaneously with the educational material items in the graphical user interface.

The educational material items used in the aforementioned method may be, for example, questions. In some embodiments, each of these questions is presented sequentially in the graphical user interface. For example, each respective question may be presented with graphical input components comprising: a first set of graphical input components configured to receive user selection of an answer to the respective question; and a second set of graphical input components configured to receive user selection of a confidence indicator for the respective question. In some embodiments, these graphical input components may also include a third set of graphical input components configured to receive user selection of a rating indicator for the respective question.

According to other embodiments, a computer-implemented method for providing educational resources to a user includes receiving user materials indicative of at least one of a user interest or user activity and a computer identifying one or more relevant terms related to the user materials. For each of a plurality of supplementary educational resources, the computer calculates a similarity score between the respective supplementary educational resource and the user materials. The computer automatically identifies one or more recommended supplementary educational resources from the supplementary educational resources based on the one or more relevant terms and the similarity scores. These recommended supplementary educational resources may then be provided to the user.

In some embodiments of the aforementioned method for providing educational resources to a user, the recommended supplementary educational resources comprise a plurality of questions. These questions may then be presented, for example, in a sequential manner in a graphical user interface. This interface may include, for example, the respective question; a first set of graphical input components configured to receive user selection of an answer to the respective question; and a second set of graphical input components configured to receive user selection of a confidence indicator for the respective question. In some embodiments, a plurality of user answer values and a plurality of user confidence values are received in response to presenting the plurality of questions. The user answer values and the user confidence values are used to determine an intuition index representative of a relationship between confidence of the user and accuracy of the user in answering the questions. In one embodiment, educational materials are presented to additional users and additional intuition indexes are generated for each additional user. Each respective additional intuition index corresponds to responses provided by a respective additional user in response to presenting educational materials to the respective additional user. Then, the original intuition index and the additional intuition indexes may be used to select a group of users for receiving targeted education materials.

In other embodiments of the aforementioned method for providing educational resources to a user, delivery of the one or more recommended supplementary educational resources to the user may be scheduled based on a list of upcoming test dates from the user. For example, in some embodiments, the recommended supplementary educational resources are sent to the user via a mobile phone application (e.g., using a push notification).

In some embodiments, the user materials comprise a video and the method further comprises identifying time points of the video during which the user activates the pause, rewound, or fast-forward functionality, selecting additional educational resources based on the time points; and providing the additional educational resources to the user.

According to another aspect of the present invention, as implemented in some embodiments, an article of manufacture for generating educational materials for a user comprises a non-transitory, tangible computer-readable medium holding computer-executable instructions for performing one or more of the methods discussed above.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an overview of a system for the intelligent delivery of educational resources based on user curriculum, requirements, and interests, according to some embodiments of the present invention;

FIG. 2 provides a high-level overview of a process utilized by a Knowledge Diffusion Platform, according to some embodiments;

FIG. 3A shows a dashboard interface which includes a scoreboard module displaying detailed information on the questions previously answered by the user, according to some embodiments;

FIG. 3B shows two screens which illustrate how the information provided in the web-based interface may be presented on a mobile device, according to some embodiments;

FIG. 4 provides an example illustration of an interface showing a push notification generated by the Knowledge Diffusion Platform, according to some embodiments of the present invention;

FIG. 5 provides a series of screens illustrating the process of answering questions generated by the Knowledge Diffusion Platform, according to some embodiments of the present invention;

FIG. 6 shows a series of screens that allow the user to generate a quiz using the Knowledge Diffusion Platform, according to some embodiments of the present invention;

FIG. 7 provides a series of screens illustrating a game-based system which allows users to compete in answering a series of questions presented by the Knowledge Diffusion Platform;

FIG. 8 provides an example of a web-based interface which demonstrates the question/flashcard-recommendation system in use, according to some embodiments;

FIG. 9 provides an example web-based interface which illustrates how users can view and manipulate study content, according to some embodiments;

FIG. 10A provides an example web-based interface illustrating a high-yield study feature, that may be used in some embodiments;

FIG. 10B provides an additional view web-based interface illustrating additional high-yield study features, according to some embodiments;

FIG. 11 provides an example web-based interface illustrating timeline search that may be available in some embodiments; and

FIG. 12 illustrates an exemplary computing environment within which embodiments of the invention may be implemented.

### DETAILED DESCRIPTION

The following disclosure describes the present invention according to several embodiments directed at methods, systems, and apparatuses for the intelligent delivery of educational resources. Users provide personal information related to their needs and interests to a software platform referred to herein as a “Knowledge Diffusion Platform.” This personal information may include, without limitation, information related to an individual's academic work (e.g., calendars, course documents, lecture audio/video, etc.), web history (e.g., pages or articles read), and/or purchase information (e.g., books or academic journal articles purchased through web-based services). The Knowledge Diffusion Platform uses the personal information of the user to select and deliver supplementary educational resources in a highly targeted manner. The disclosed systems, methods, and apparatuses described herein are generally applicable to any academic discipline.

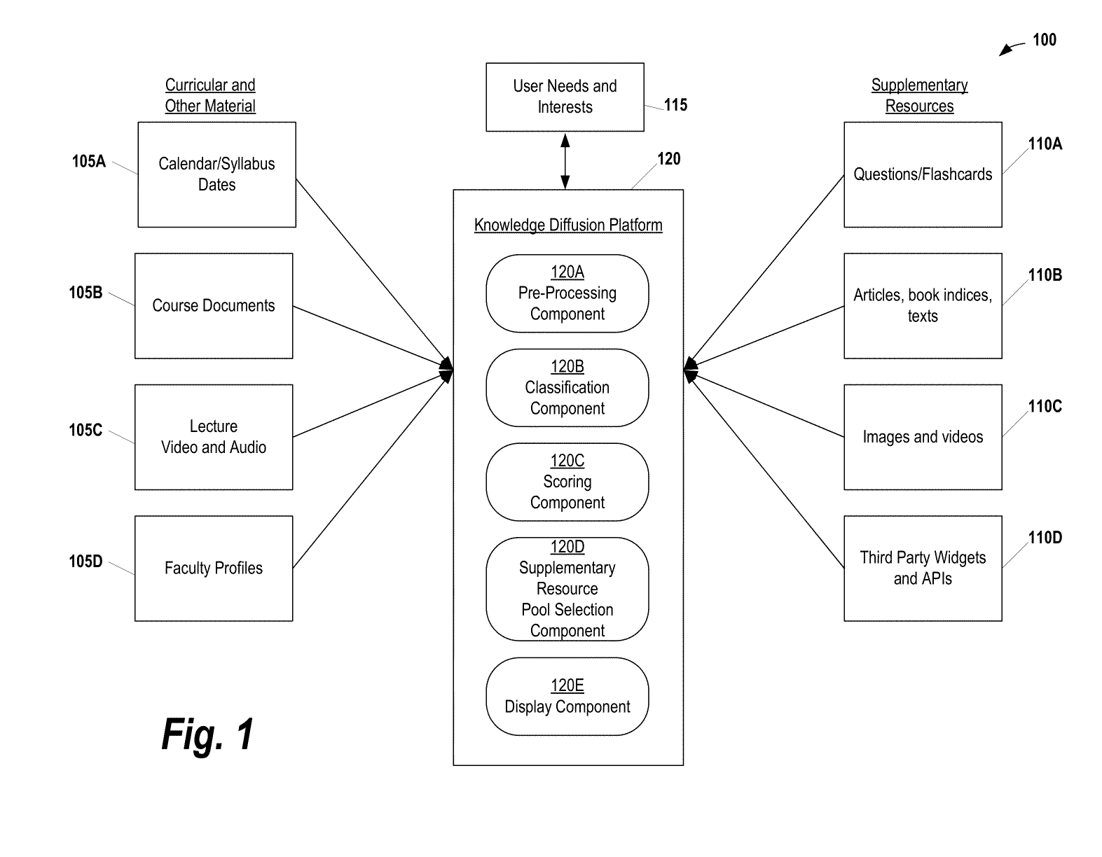

FIG. 1 provides an overview of a system 100 for the intelligent delivery of educational resources based on user curriculum, requirements, and interests, according to some embodiments of the present invention. Briefly, a Knowledge Diffusion Platform 120 receives input data over network (e.g. the Internet) and processes that data to identify and deliver the educational resources to a user. Part of input data to the Knowledge Diffusion Platform 120 may include Curricular Material such as, for example, relevant dates from a syllabus or academic calendar 105A, course documents 105B, audio and video of lectures 105C, and/or faculty profile information 105D. This information may be retrieved, for example, through interaction with a website operated by the corresponding academic institution or through direct input from the user.

Continuing with reference to FIG. 1, User Needs and Interests 115 are also provided to the Knowledge Diffusion Platform 120. In some embodiments, these interests are specific to the user, and may be curricular or extracurricular in nature. For example, for a pre-medical student, the date of a test or examination, such as the MCAT may be one of the User Needs and Interests 115 provided to the Knowledge Diffusion Platform 120. The Knowledge Diffusion Platform 120 may ask the user to define interests or it may rely on how the user interacts with the resources on the Platform to generate an interest map. The Knowledge Diffusion Platform 120 may also collect various additional personal information about the user. This personal information may include, without limitation, name, e-mail address, gender, institution, class year, and country. The personal information can be provided directly by a user (e.g., during registration) or, in some instances, it may be derived based on information provided by the user. For example, gender can be derived using tools such as Python SexMachine, Gender.io, Gender-API, with adjustable accuracy thresholds. Institution can be derived from email, though there may be some exceptions when student uses college email address.

Additionally, Supplementary Resources are provided to the Knowledge Diffusion Platform 120. The Supplementary Resources may include educational material items such as, for example, Questions/Flashcards 110A, Articles 110B, Images and Video 110C, and/or Third Party Widgets and APIs 110D. The Articles 110B may be acquired from any source (e.g., PubMed, New York Times, blogs, etc.) using any technology generally known in the art (e.g., RSS feeds, APIs). Similarly, the Images and Video 110C may be acquired from various web-based sources (e.g., Wikipedia, Gov, Figure1, YouTube, Vimeo, Publisher, etc.) and, in some instances, may be uploaded from offline sources. The Third Party Widgets and APIs 110D may be used to retrieve third party educational material and other content (e.g., BioDigital Human, Twitter, YouTube, HealthTap, LinkedIn, Twitter, Facebook, AngelList, etc.) using web-interfaces (typically supported directly by the content provider).

At the core of the system 100 is a Knowledge Diffusion Platform 120 that recommends supplementary educational material items to a user based on information encountered by the user within day-to-day activities (e.g., any articles read and/or documents provided by an academic institution) as well as his or her specific interests and needs. The Knowledge Diffusion Platform 120 is, for example, a web or mobile software application designed to deliver educational material items to the user so that he or she can learn and retain information more efficiently. The Knowledge Diffusion Platform 120 uses machine learning algorithms (proprietary or non-proprietary in nature) that drive non-random recommendations of educational material items. Recommended resources may be delivered through multiple web- and/or mobile-enabled mechanisms that may include, for example, push notifications, text messages, in-app updates, news-feed updates, and e-mails. The Knowledge Diffusion Platform 120 is optimized to identify and deliver resources that are primarily educational to a user. These include, but are not limited to, questions, images, videos, mnemonics, articles, social media feeds and profiles, and information about a particular lecturer. However, it should be noted that, while some of the delivered resources may be defined as educational, others may not initially be thought of in that way (e.g., social media feeds of relevance to the curriculum).

The Knowledge Diffusion Platform 120 shown in FIG. 1 includes five components (i.e., components 120A, 120B, 120C, 120D, and 120E) which illustrate, on a high-level, the functionality of the platform. The Pre-Processing Component 120A performs tasks such as cleaning the data (e.g., removing unneeded information), normalizing the data, and/or transforming the data into a format used by the Knowledge Diffusion Platform 120. In some embodiments, the Pre-Processing Component 120A may also temporally group the input data. For example, academic documents may be grouped by the day and time they are taught. If slides and notes are provided for an 8 a.m. lecture, the text of both may be concatenated for analysis. The assumption is that more text for similar documents will result in a higher signal to noise ratio during later processing by the Knowledge Diffusion Platform 120.

In some embodiments, the Pre-Processing Component 120A also includes a tokenization system which tokenizes the words in the input material. In this context, “tokenization” refers to the grouping of works that constitute a single term. For example, multiple sclerosis is normally seen by a computer as two words, but the machine learning system may be used to identify it as a single entity. In some embodiments, the tokenization system employed is Wikipedia Miner. Wikipedia Miner performs tokenization by analyzing the link structure of Wikipedia and uses this model to assign a probability that a certain word or set of words is a specific term given the surrounding textual context. In some embodiments, a corpus of terms may be created offline by analyzing a large set of documents to form a token lookup dictionary. This dictionary may then be used to perform the tokenization.

The Classification Component 120B uses one or more classification techniques to classify input materials into knowledge domains. The term “knowledge domain” as used herein refers to a particular field of study or subject area. For example, in the context of medical studies, examples of knowledge domain may include anatomy, genetics, cell physiology, immunology, microbiology, hematology, neurology, cardiology, etc. Various types of classification techniques may be used to map input materials to knowledge domains. For example, in some embodiments, a histogram-based classification is used. When an input document arrives, a map of terms to knowledge domains is used to create a histogram of the available or known knowledge domains. The highest histogram bin is then selected as the knowledge domain for the incoming document. In other embodiments, the Classification Component 120B may utilize other classifier techniques including supervised, unsupervised, and/or semi-supervised machine learning techniques for automatic document classification generally known in the art.

The Scoring Component 120C applies machine learning algorithms such as term frequency-inverse document frequency (TFIDF) and/or latent Dirichlet allocation (LDA) to each input data item to identify relevant terms in the input materials. For example, in some embodiments, the Scoring Component 120C computes a TFIDF score for every word in the input materials. The term frequency varies with every item of input material but the inverse document frequency for a term is a function of that term with respect to the chosen knowledge domain (i.e. it may be computed a priori). In some embodiments, the TFIDF score is computed for tokenized terms. In other embodiments, the score is computed for every term in the input materials. The benefit of the latter is to enhance the context with words that might not be tokenized terms but might be important in the context of identified terms. TFIDF essentially can be broken down into a two-part scoring metric: the term frequency and the inverse document frequency. The “term frequency” is the frequency of a given term in the current document and may be determined by counting the number of occurrences over the total number of words. The “inverse document frequency” refers to how common the term is in a representative a priori corpus of documents for a particular knowledge domain.

To illustrate the operation of the Scoring Component 120C, consider a training data set of approximately 100 sample documents and articles from each of 18 knowledge domains: anatomy, biochemistry, metabolism, genetics, cell physiology, immunology, microbiology, hematology, neurology, psychiatry, cardiology, nephrology, pulmonology, endocrinology, reproduction, gastroenterology, rheumatology, and dermatology. The 100 sample documents may be used to compute the inverse document frequency for the 18 knowledge domains. This example can be varied and scaled according to the size of the training data set and the number of knowledge domains.

The Supplementary Resource Pool Selection Component 120D uses the information generated by the Scoring Component 120C to create or curate a pool of questions for a particular knowledge domain. For example, in some embodiments, a score is determined for each word in the document and each word in the question. Then, the two texts are compared as if they were vectors in a high dimensional space (i.e., the cosine similarity is like finding the angle between two high dimensional vectors using the dot product). A low threshold may be used to select possible question matches. This primarily weeds out completely irrelevant content or content that otherwise would be weighted as important relative to the knowledge domain simply because of a high frequency of occurrence (e.g., mistakenly pulling all the heart questions in cardio just because the term “heart” was mentioned).

In some embodiments, during generation of the pool of questions, the Supplementary Resource Pool Selection Component 120D tokenizes questions for comparison to tokenized input text. If at least one tokenized term is present in both the input text and the question, the question is added to the pool of possible questions to be selected. In some embodiments, the Supplementary Resource Pool Selection Component 120D may also perform filtering for short questions by again comparing the question text to the document text. If at least 50% of the terms in the short question show up in the document text, the question is selected for the pool. For longer questions, short questions or facts can be manually matched a priori and the same filter can be applied against the short fact counterparts of longer questions. This produces higher quality results for longer questions which contain more noise simply by having more non-specific text (e.g., distractor choice explanations, question stem, etc.).

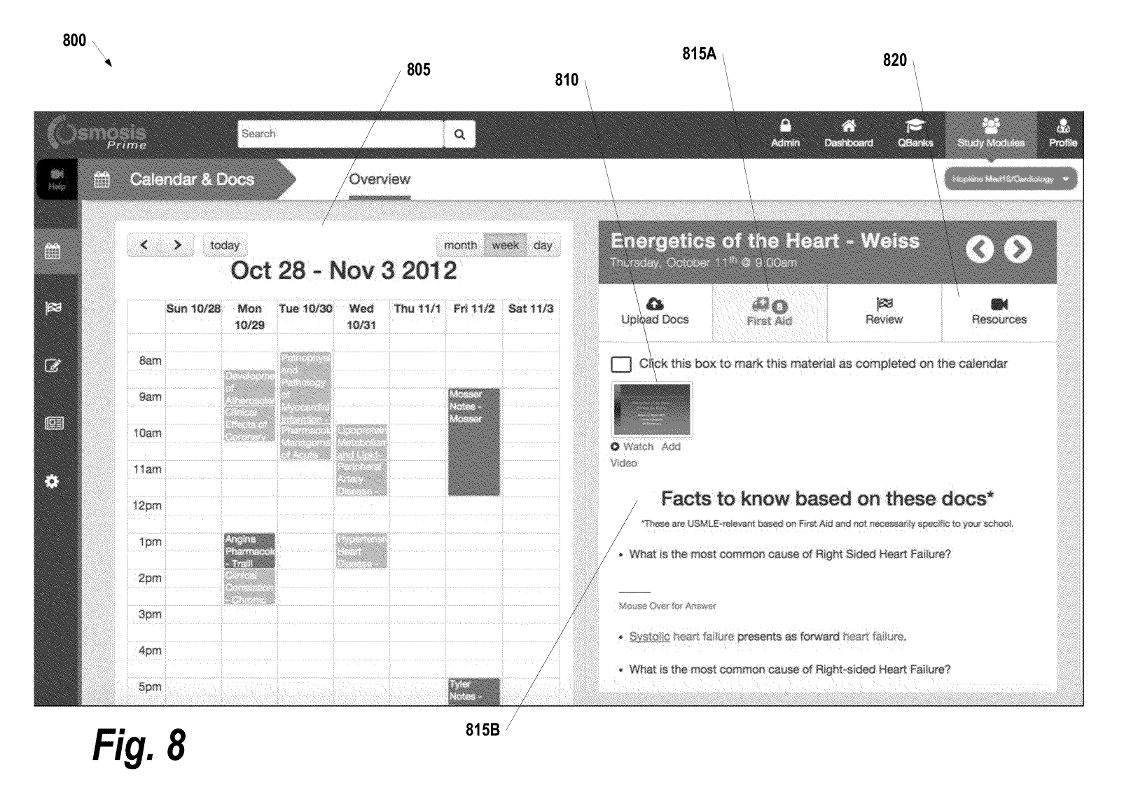

The Display Component 120E is used to present the questions from the pool and other relevant material for display to a user. Various display techniques may be employed including, for example, web-based interfaces, interfaces presented in mobile apps, e-mail, and push alerts. FIGS. 8-11 provide examples interfaces that may be generated by the Display Component 120E, according to various embodiments of the present invention.

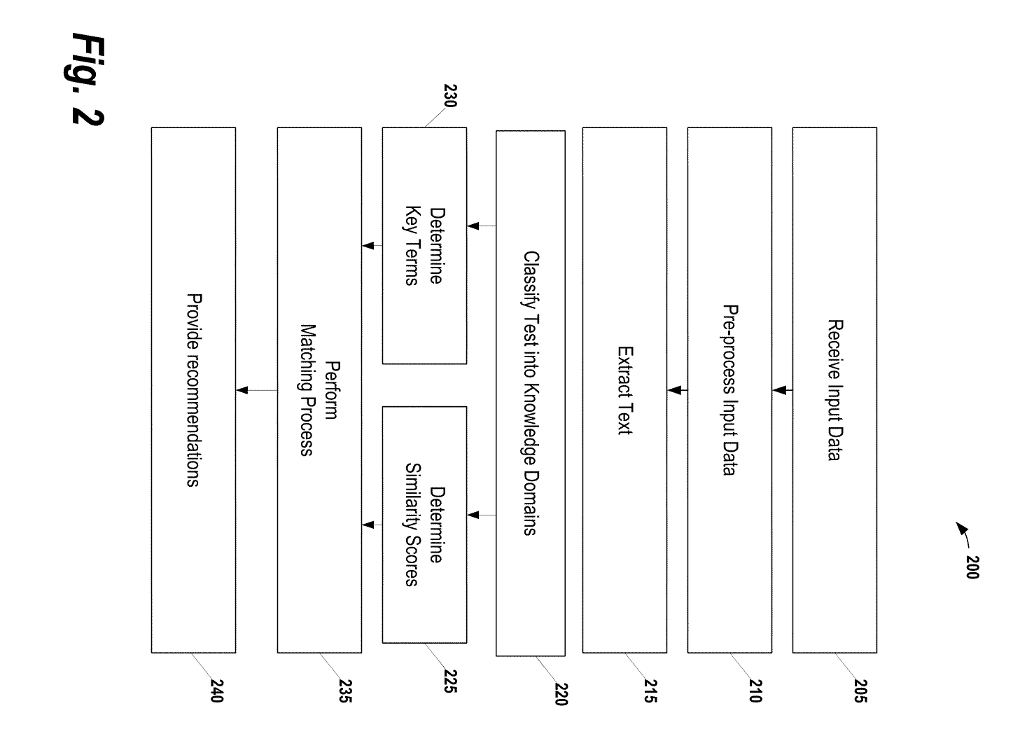

FIG. 2 provides a high-level overview of a process 200 utilized by a Knowledge Diffusion Platform, according to some embodiments of the present invention. In this example, recommended questions and flashcards/factoids are generated based on input data provided by the user. At step 205, this input data is received, for example, through user input such as uploading data via a web or mobile software application. This input data may include, for example, curricular materials, supplementary resources, online and/or offline reading history (e.g., blog posts or articles read), and/or information corresponding to user needs and interests. At step 210, the input data is pre-processed to transform it into a format suitable for storage and used by the Knowledge Diffusion Platform, as discussed above with reference to the Pre-Processing Component 120A.

Once the input data has been pre-processed, at step 215, text from the input data is extracted. The exact process used in extracting the text will depend on the medium of the input data. For example, while the text of journal articles can be directly extracted, the Knowledge Diffusion Platform may utilize closed-captioning data or metadata for video data. In some embodiments, the extracted terms may also be tokenized at step 215, for example, using a machine learning system to group words as entities (i.e., tokens). Next, at step 220, the extracted (and possibly tokenized) text is classified into one or more knowledge domains (see the description of the Classification Component 120B in FIG. 1).

Once the knowledge domain has been determined, at step 225, the similarity score may be determined based on factors such as the frequency that keywords associated with the knowledge domain appear in the input materials being processed. For example, lecture notes on brain physiology may have a high similarity score with respect to a medical journal article on functional magnetic resonance imaging, but a low similarity score with respect to non-invasive abdominal surgery. At step 230, the text extracted at 215 is utilized to identify keywords and other relevant terms for each input data item. In some embodiments, machine learning algorithms such as term frequency-inverse document frequency (TFIDF) and/or latent Dirichlet allocation (LDA) may also be applied to each input data item to identify relevant terms.

Continuing with reference to FIG. 2, at step 235, a matching process is performed using the identified terms and similarity scores to yield a set of possible question matches. Because the keyword identification performed at 230 may be slow, questions are tokenized and the tokenized document text is compared to the tokenized question text. If at least one tokenized term is present in both the input text and the question, the question is added to the pool of possible questions to be selected. Next, a score (e.g., TFIDF score) is computed for all questions in the pool and the cosine similarity is then computed for the input document against each possible question in the pool. Optionally, after the matching process is performed at step 235, short questions may be filtered.

At step 240, the final set of recommended questions and flashcards/factoids are then presented alongside the document. In some embodiments, the questions and flashcards/factoids are pushed to the user only after receiving an indication that the user has reviewed the original document. As part of these recommendations generated using the process 200 illustrated in FIG. 2, supplementary material may be displayed alongside curricular material via the Knowledge Diffusion Platform. For example, a student may upload a 40-slide PowerPoint presentation on BRCA genes given by Dr. Jane Doe to the Knowledge Diffusion Platform. The Knowledge Diffusion Platform may automatically recommend resources such as practice questions related to BRCA; reference material like Wikipedia and UpToDate; YouTube videos and images; page numbers from First Aid medical reference books; Dr. Jane Doe's Twitter, LinkedIn, and PubMed profiles; and/or recent NYT articles on BRCA.

Aside from direct user input, in some embodiments, the Knowledge Diffusion Platform may gather information on a user via automated techniques. For example, in some embodiments, keywords from web searches (or text displayed in the browser window, as in the case of reading material) are tracked through a browser extension installed by the user. Such a browser extension may additionally (or alternatively) convert reference article text into input for algorithms executed by the Knowledge Diffusion Platform. The Knowledge Diffusion Platform may also track a user's interaction with electronic medical records (EMRs) and/or electronic health records (EHRs) to identify relevant content. For example, the Knowledge Diffusion Platform may identify issues encountered by a medical student during a clinical rotation by analyzing the EHRs and EMRs accessed by the student during the rotation. Content which is relevant to these issues can then be targeted to the user. A user's interaction with EMRs and EHRs may be tracked in various ways. For example, a browser extension similar to that discussed above may be employed. Alternatively, the Knowledge Diffusion Platform may include EMR/EHR browser (e.g., as part of a mobile application) which directly tracks a user's interactions.

In some embodiments, The Knowledge Diffusion Platform may also analyze a user's viewing behavior on audio and video recordings to extract meaningful information. For example, in one embodiment, a heat map is used to depict time points of the audio/video during which users paused, rewound, or fast-forwarded. For example, say 40 students watch a given video recording, of a lecture or YouTube video. If 20 of those students pause at time point 15:45 and rewind 30 seconds that may represent an area of the video that was unclear. Based on this information the Knowledge Diffusion Platform can recommend additional resources or notify the lecturer or institution so that clarifications are provided as necessary. Similarly, average viewing speeds can be shared to provide additional insight.

Additionally, because users will be spending a great deal of time interacting with the Knowledge Diffusion Platform while studying, it has the potential of being a valuable advertising medium. Thus, in some embodiments, the Knowledge Diffusion Platform may provide advertisements to the user, for example, based on analysis of the user's course documents.

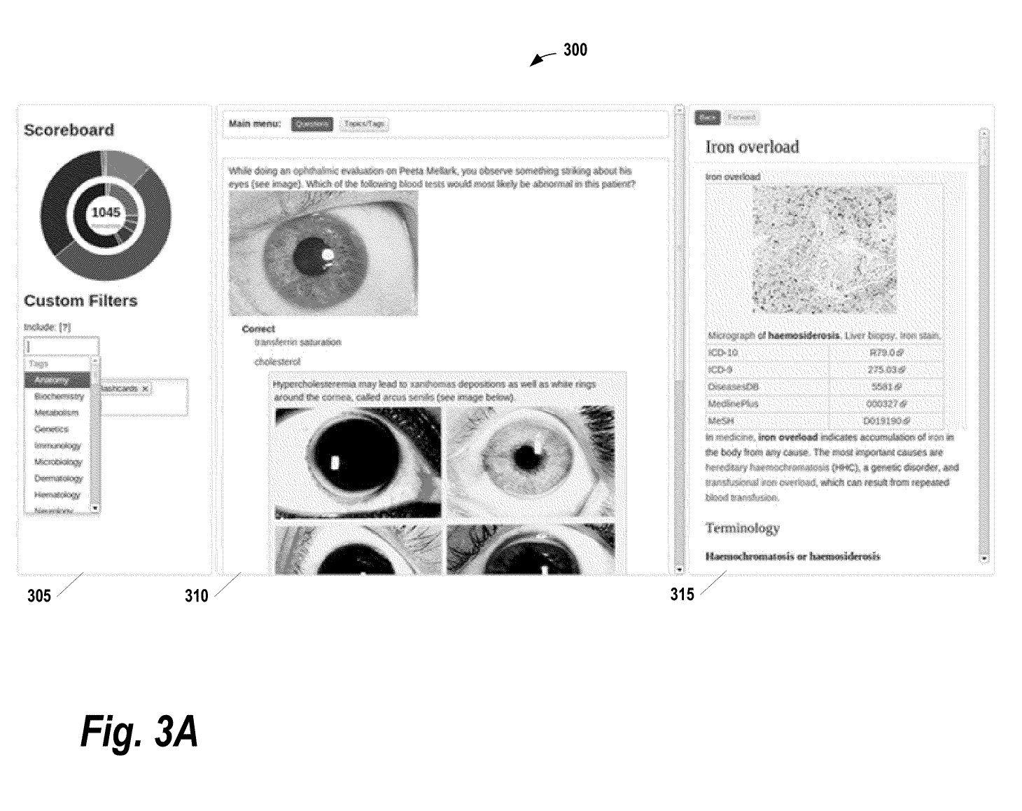

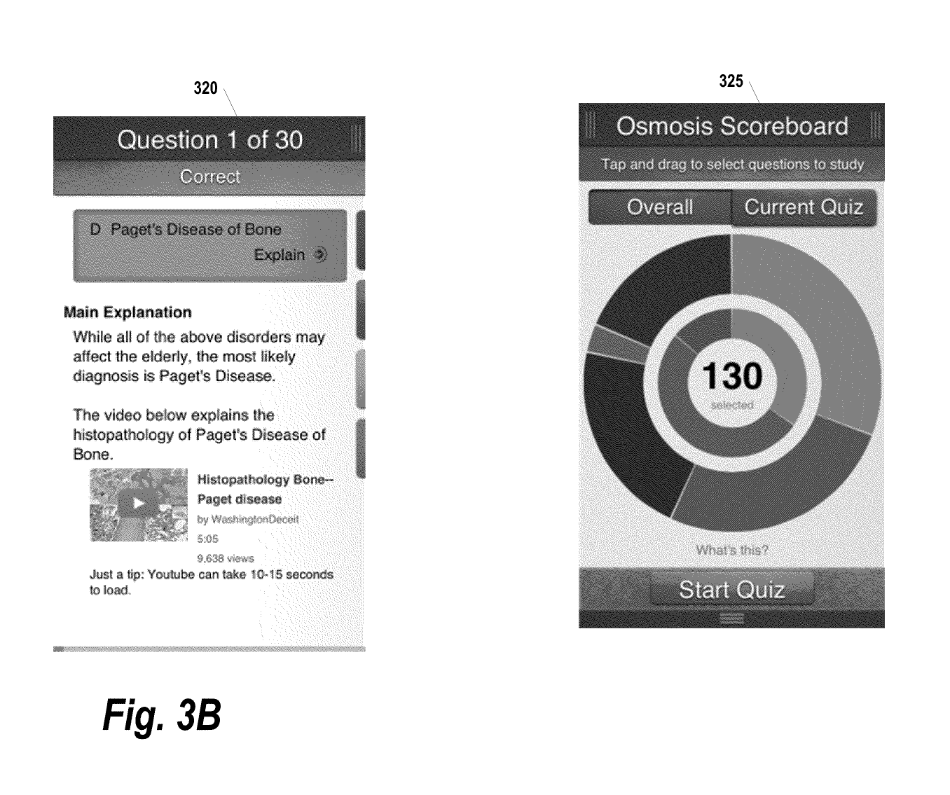

FIGS. 3A and 3B provide examples of the interfaces that may be used to display supplementary material using a web-based or a mobile-based application, respectively, according to some embodiments of the present invention. Each of these examples demonstrates how question information may be presented to the user. FIG. 3A shows a dashboard interface 300 which includes a scoreboard module 305 displaying detailed information on the questions previously answered by the user. The scoreboard module 305 includes two concentric rings. In some embodiments, the outer ring provides a color-coded indication of the confidence and accuracy with which a user answered a set of questions. Green segments may represent questions that were correctly answered, red segments may represent incorrectly answered questions, and grey segments may represent skipped or new questions. Shading may be used to represent confidence, with bright representing “I'm Sure,” medium representing “I'm Feeling Lucky,” and dark representing “No Clue.” The inner ring may be used to signify how recently the questions were answered. Brighter colors may be used to represent recently answered questions and darker/black segments may be used to represent questions answered long ago. Clicking or tapping on particular segments of the scoreboard module 305 may automatically select those questions through a filtering mechanism. For example, clicking on the outer ring's bright red segment may automatically bring up only the subset of questions that were incorrectly answered with high confidence (“I'm Sure”). Additionally, the scoreboard module 305 includes a dropdown menu which allows users to select filters and tags which help the user visualize a particular subset of data. For example, the user may select an “Anatomy” filter and the concentric circles will only show information about questions related to anatomy. The dashboard interface 300 also includes a question module 310 which presents questions to the user and allows the user to select answers and indicate confidence levels with respect to the selected answer. In embodiments such as that depicted in FIG. 3A, the dashboard interface 300 also includes a supplementary material module 315 which presents additional relevant information regarding the general subject area of the presented question or the correct answer to the presented question.

FIG. 3B shows two screens which illustrate how the information provided in the dashboard interface 300 may be presented on a mobile device. Image 320 shows how a question may be presented, along with an explanation of the correct answer. Image 325 shows how information presented in the scoreboard module 305 shown in FIG. 3A may be displayed on a mobile application. The mobile device interface provides several advantages that may not be available via the web-based service. For example, in some embodiments, an “intelligent push.” system is used to deliver questions and other notifications to users.

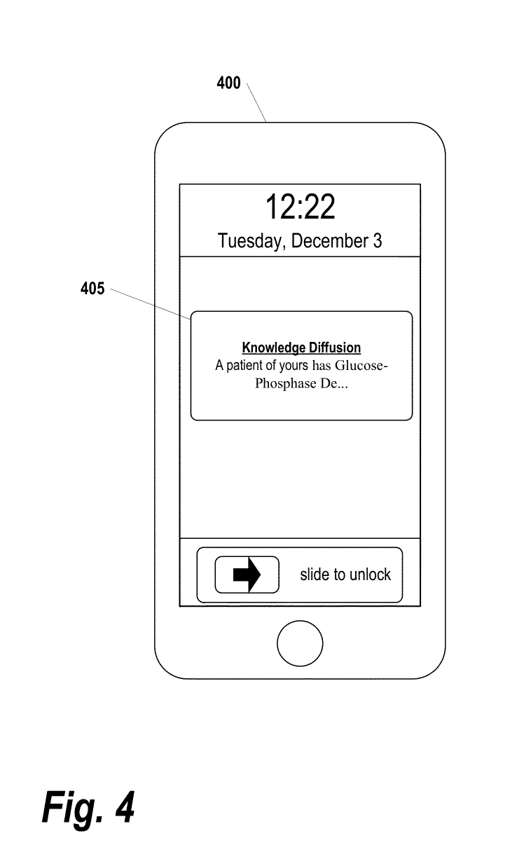

FIG. 4 provides an example illustration of an interface 400 showing a push notification 405 generated by a Knowledge Diffusion Platform (see, e.g., FIG. 1), according to some embodiments. The term “notification” is used broadly to describe any message transmitted to the user. For example, where a custom application associated with the Knowledge Diffusion Platform is installed on the user's phone, the user may receive a push alert via a service associated with the devices (e.g., Apple Push Notification service or Google Cloud Messaging). Alternatively, the “notification” may be an email or text message. The push of the notification is intelligent in the sense, that the Knowledge Diffusion Platform will dynamically change factors such as the number of push notifications per day (i.e., frequency), at what point(s) throughout the day they are sent (i.e., timing), and/or which specific topics they cover (content). In some embodiments, the Knowledge Diffusion Platform dynamically changes the frequency, timing, and content of its push notifications depending on the user's calendar. Information about the user's calendar may be manually input or automatically derived from a course syllabus or third party calendar application, such as Google Calendar™, Apple's iCal™, or Microsoft Outlook™ For example, an undergraduate student may import their Google Calendar™ or syllabus into The Knowledge Diffusion Platform and his or her push schedule will dynamically change based on this new information. Another illustrative example is a medical student that manually inputs their block- or shelf-exam dates (e.g. Cardiology on February 15, Microbiology on March 20). Leading up to February 15^{th}, the student is sent an increasing number of cardiology practice questions. The medical student may continue to receive intermittent cardiology quizzes even after the exam to keep her fresh on that knowledge.

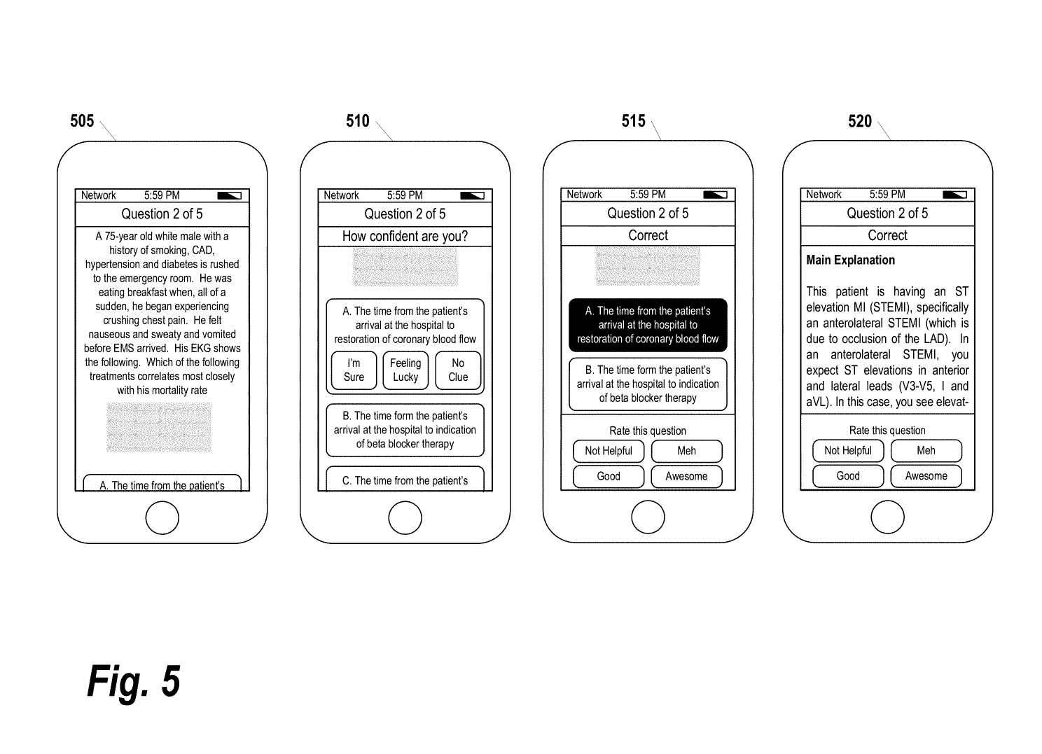

FIG. 5 provides a series of screens illustrating the process of answering questions generated by a Knowledge Diffusion Platform (see, e.g., FIG. 1), according to some embodiments of the present invention. These screens show the process as it is implemented on a mobile device, however it should be understood that a similar process is implemented in a web-based interface. The initial screen 505 shows a question which includes text explaining a list of symptoms and a graphic depicting an Electrocardiogram (ECG) output. The user is then asked which of a group of possible treatments correlates most closely with mortality rate. In screen 510, the user has selected answer “A,” for example, by tapping on the screen, and a blue box is placed around the question to indicate the user's selection. The user is then presented with a series of buttons that allow the user to specify how confident he or she is in the answer. In the example of FIG. 5 there are three options for indicating confidence: “I'm Sure,” “Feeling Lucky,” and “No Clue.” Once the user indicates confidence, screen 515 is displayed which informs the user whether or not the answer is correct. Screen 515 includes rating buttons at the bottom of the display which allow the user to rate the quality of the question as “Not Helpful,” “Meh,” “Good” and “Awesome.” This quality information may be stored and correlated with the question to optimize future question selection for the user, as well as question selection for other users. If the user scrolls (e.g., drags) down on the interface, screen 520 is displayed which provides an explanation of the correct answer. The user may then either rate the question using the aforementioned rating buttons or swipe the screen to move to the next question.

In some embodiments, the Knowledge Diffusion Platform uses the confidence information provided by students to determine an Intuition Index (also referred to as a Calibration Index) which describes the relationship between a user's confidence and accuracy in answering a question. The Intuition Index is an indicator of a particular user's meta-knowledge. The Intuition Index may be calculated, for example, using a bias equation, or other measures such as psychometric calibration equation. For example, in one embodiment, the following formulas may be used in calculating the Intuition Index:

$$\begin{matrix}bias = \frac{1}{n} {\sum }_{i = 1}^{n} ( {c}_{i} - {p}_{i} ) & ( 1 ) \\ abs . bias = \sqrt{\frac{1}{n} {\sum }_{i = 1}^{n} {( {c}_{i} - {p}_{i} )}^{2}} & ( 2 )\end{matrix}$$

Where cᵢ represents the confidence, pᵢ represents the performance, and n is the number of questions answered. Various optimizations may be applied when calculating the Intuition Index. For example, the Knowledge Diffusion Platform may only analyze the first time someone answers a particular question or analyze all recorded answers. The Knowledge Diffusion Platform may remove data from users who answer a predetermined percentage of questions with the same confidence level to avoid having the Intuition Index biased by users gaming their confidence response or otherwise not providing accurate confidence information. Although the examples set out above show a relationship between confidence and accuracy, in other embodiments, additional variables such as time-to-answer may be incorporated into the Intuition Index.

Once the Intuition Index has been calculated across a group of users, it may be used to determine various information about the user base. For example, the Knowledge Diffusion Platform may provide information about how the Intuition Index varies based on factors such as gender, class year, institution, time of day that questions were answered, country of origin or use, device type, topic, rating of question, or type of question (e.g., clinical vignette vs. fact or multiple-choice vs. true/false). In this way, various insights into the user base may be determined. For example, when someone answers a question with a confidence indication of “I'm Sure” and gets it wrong, are they more likely to rate a question “Meh” or “Not Helpful”? (assuming the question is valid). Are males/females more likely to rate a question “Awesome” and “Good” compared to “Meh” and “Not Helpful”? What is the stability of individual bias over time? Moreover, the Intuition Index may be used to target training for a particular set of users. For example, if some users are not confident in their answers, a randomized controlled trial (RCT) may be conducted to see if an intervention can improve user confidence or increase alignment of confidence and accuracy.

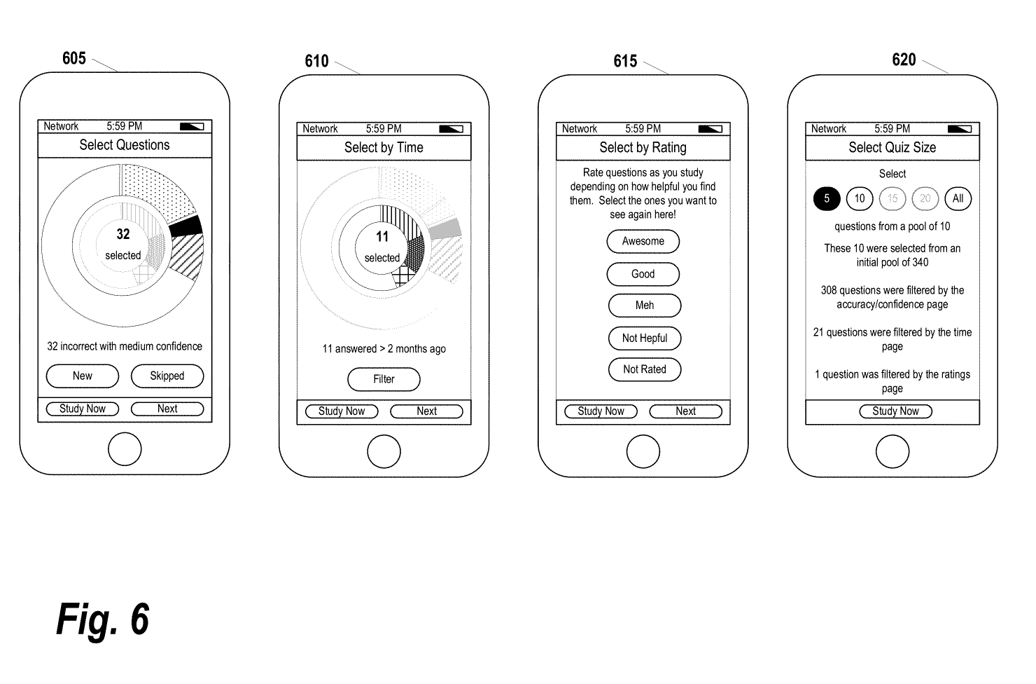

FIG. 6 shows a series of screens that allow the user to generate a quiz using the Knowledge Diffusion Platform, according to some embodiments of the present invention. The first screen 605 shows an interface that allows users to select a confidence level for the questions that will be used in the quiz. On the screen 605, the user has selected questions that the user has previously answered incorrectly, but indicated “medium” confidence. As noted previously, after answering a question and before seeing an answer, the user provides an indication of their confidence. This confidence level provides an additional dimension for targeting areas which require additional study. With reference to screen 605, this confidence information allows the user to specifically target questions that the user believed were correct, but were not. Thus, the quiz generated in this example would not include other types of questions such as questions that the user answered incorrectly, but indicated that they had low confidence in their guesses.

Continuing with reference to FIG. 6, screen 610 allows the user to filter questions based on time. For example, the user can use this screen 610 to indicate that the quiz should only include questions that the user has not answered for two or more months. The next screen 615 allows the user to filter questions for the quiz based on rating. As the user answers questions provided by the Knowledge Diffusion Platform, they can provide a rating of how helpful they find them. For example, with reference to screen 615, these levels include “Awesome”, “Good,” “Meh,” “Not Helpful,” and “Not Rated.” Thus, using screen 615, the user can quickly eliminate a subset of the questions (e.g., “Not Helpful”) from the quiz depending on their ratings. Finally, screen 620 allows the user to select the size (i.e., number of questions) in the quiz and provides additional information regarding the filters used in the previous steps when generating the question based for the quiz. A button at the bottom of the screen 620 allows the user to begin the quiz.

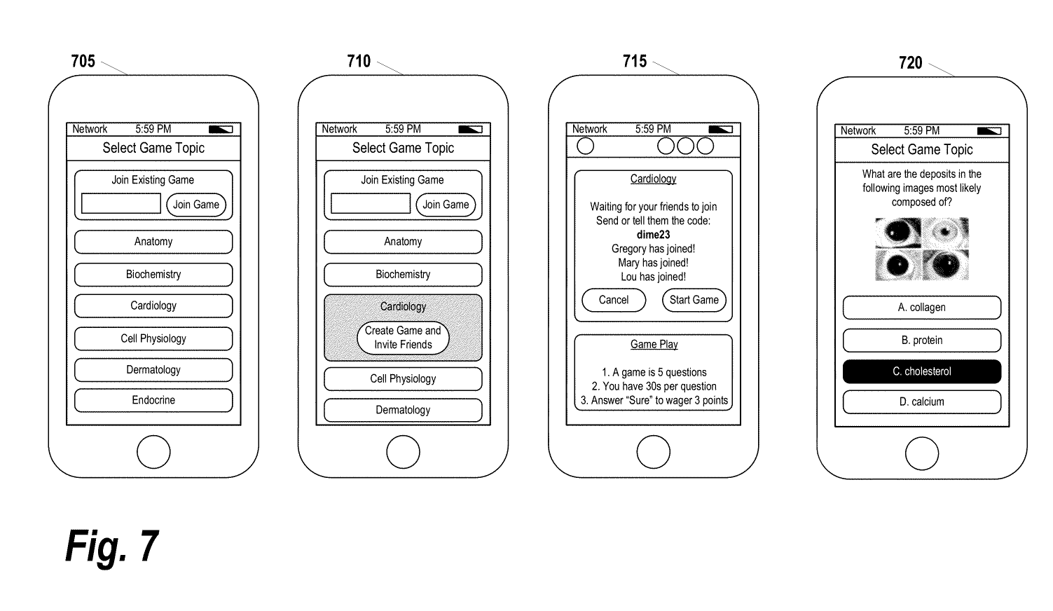

FIG. 7 provides a series of screens illustrating a game-based system which allows users to compete in answering a series of questions presented by the Knowledge Diffusion Platform, according to some embodiments. Image 705 shows an interface which presents the user with a series of game topics. Each game topic corresponds to a series of questions about a particular study topic. Thus, in 705 these game topics include Anatomy, Biochemistry, Cardiology, etc. The user selects one of the game topics, for example, by tapping on the game topic on the screen. Next, screen 710 is presented which includes a button which allows the user to create a game. After selecting this button (e.g., by tapping), the game is created and the user is presented with screen 715 which allows users to invite other users to play the game. In some embodiments, a code (e.g., “dime23”) may be used to invite other users to play the game. The users who have accepted the invitation may be presented on the interface. For example, in screen 715, the users are represented as small circles at the top of the screen. Then, each user participating in the game is presented with the questions. Screen 720 shows one example of how the questions may be presented. The circles at the top of the screen may be modified (e.g., via a change in color) to indicate whether other users have answered the questions correctly or incorrectly. In some embodiments, the game utilizes confidence score as a wager. For example, following the presentation of a question, the user may be presented with three options for indicating his or her confidence in the selected answer: “sure,” “feeling lucky,” and “no clue.” Each confidence level is associated with a wager that determines the number of points awarded or lost when answering the questions. For example, a correct answer with a confidence level of “sure” may earn the user 3 points, while a correct answer with a confidence level of “feeling lucky” or “no clue” may earn the user 2 or 1 points, respectively. Similarly, an incorrect answer with a confidence level of “sure” may lose the user 3 points, while an incorrect answer with a confidence level of “feeling lucky” or “no clue” may lose the user 2 or 1 points, respectively. It should be noted that these confidence levels are merely examples and, in other embodiments, additional confidence levels may be used within the scope of the present invention. After the users complete the game, they can review how each user ranked (i.e., who “won” the game). Additionally, each user can review each of the questions they answered and see an explanation of the correct answer provided by the Knowledge Diffusion Platform.

FIG. 8 provides an example web-based interface 800 which demonstrates the question/flashcard-recommendation system in use, according to some embodiments. Calendar 805 is embedded into the interface. Each block in the calendar signifies an event, with the shading representing whether the documents for that particular event have been reviewed or not. This enables the Knowledge Diffusion Platform to determine which documents have been reviewed and thus which material should be pushed to the user. A clickable Document Thumbnail 810 shows what document(s) are available under this event. The text of this document has been processed as described in FIG. 2. A First Aid Button 815A includes an alert (indicated by the number “8” in a circle) indicating that 8 recommended facts (e.g., questions and/or flashcards) have been identified to be relevant to the document(s) in this event. The recommended facts are shown in Text Section 815B based on the document text. In some embodiments, the Knowledge Diffusion Platform has a scroll-to-display-answer feature and, uniquely, enables the learner to “Schedule for Review” which will send the question to their mobile app after. A Resource Button 820 may be activated to view other resources such as images, videos, and articles that are also tagged to the document(s).

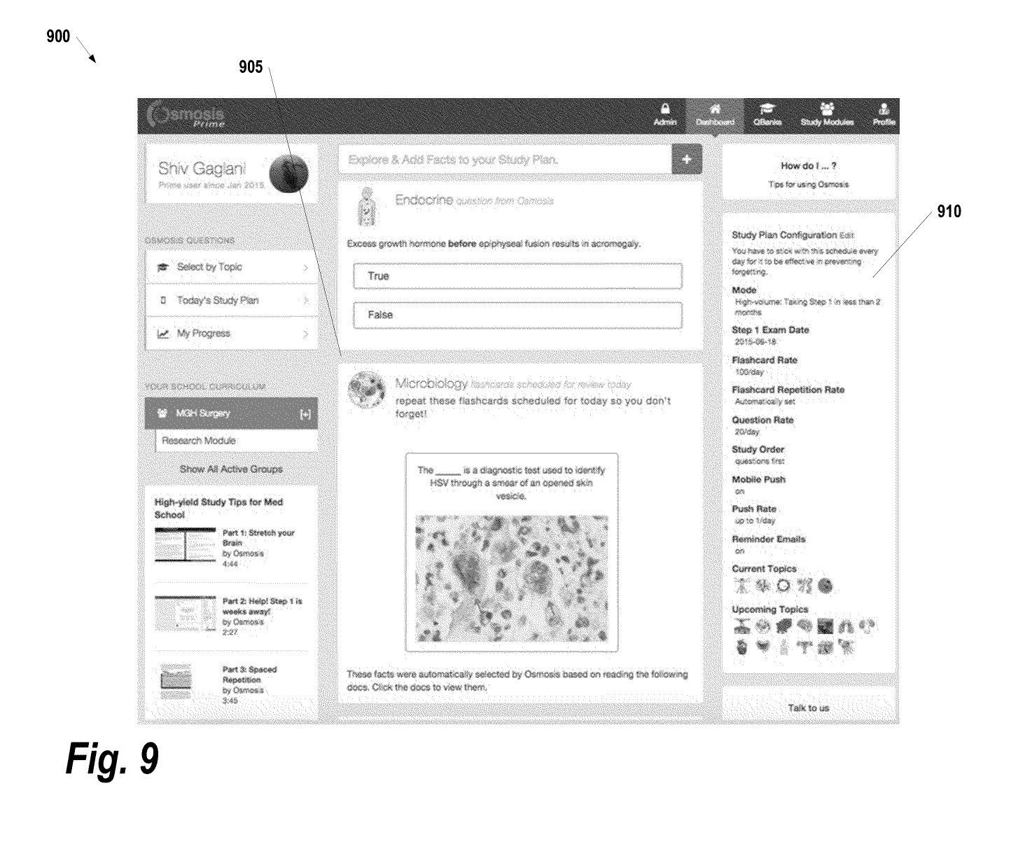

FIG. 9 provides an example web-based interface 900 which illustrates how users can view and manipulate study content, according to some embodiments. Newsfeed Interface 905 allows the Knowledge Diffusion Platform to deliver questions and other content using stacked visual components. In the example of FIG. 9, an endocrinology question is stacked over a microbiology flashcard. In this manner, various materials may be integrated for quick review by the user. In some embodiments, the items in the Newsfeed Interface 905 are prioritized according to criteria such as, for example, upcoming important dates, areas where the user's knowledge base is weak or user-selected preferences.

The interface shown in FIG. 9 also includes a Study Plan Configuration Interface 910 which enables users to manually create study schedules by specifying items such as topics and question type, frequency, and delivery method. For example, the Study Plan Configuration Interface 910 includes an indication of the study mode, the upcoming exam date, the rate at which flash cards should be presented, the rate at which flashcards should be repeated, the question rate, the study order (i.e., question first, flashcards first, random, etc.), whether questions should be pushed to the user's mobile device (and the frequency of such pushes), an indication of whether emails should be sent to the user with study reminders, and a list of current and upcoming topics. Some of the items listed are depended on one another. For example, the study mode provides indication of the volume at which information should be reviewed. If the exam date is within the next 2 months (as shown in the Study Plan Configuration Interface 910), the study mode may be set to high-volume to help the user review as much material as possible before the test. A hyperlink presented in the Study Plan Configuration Interface 910 (labeled “Edit” in FIG. 9) may be activated to change the information included in the study plan.

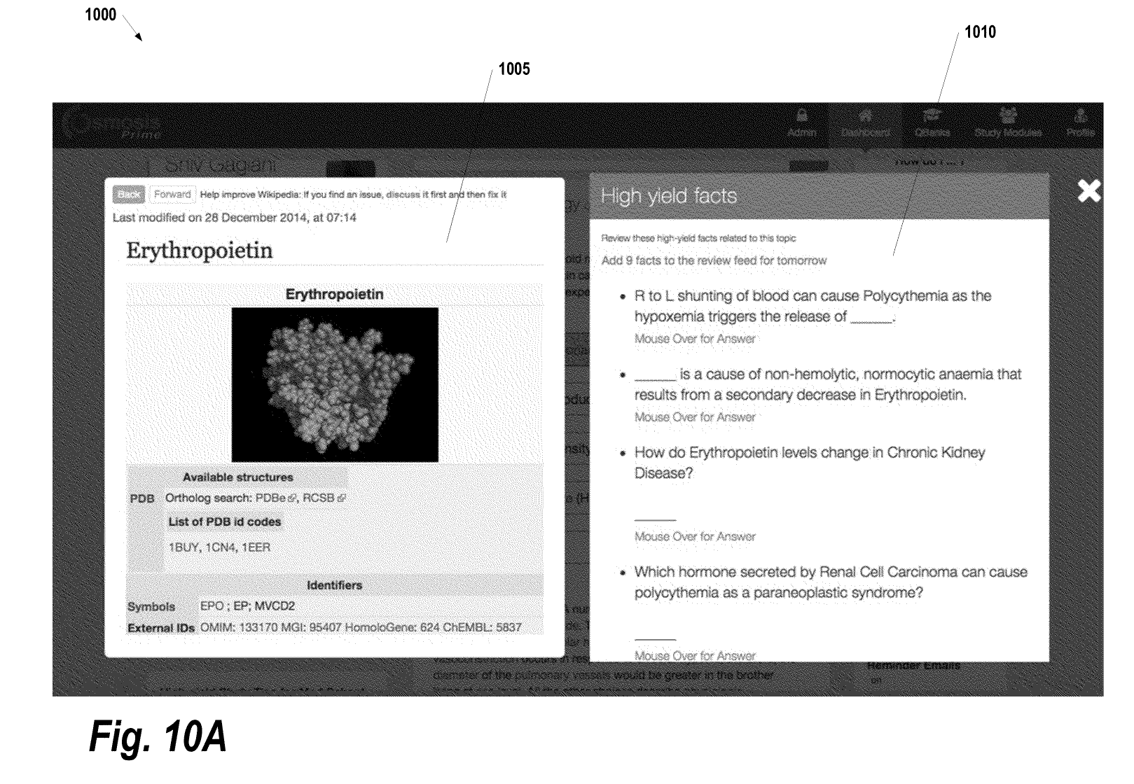

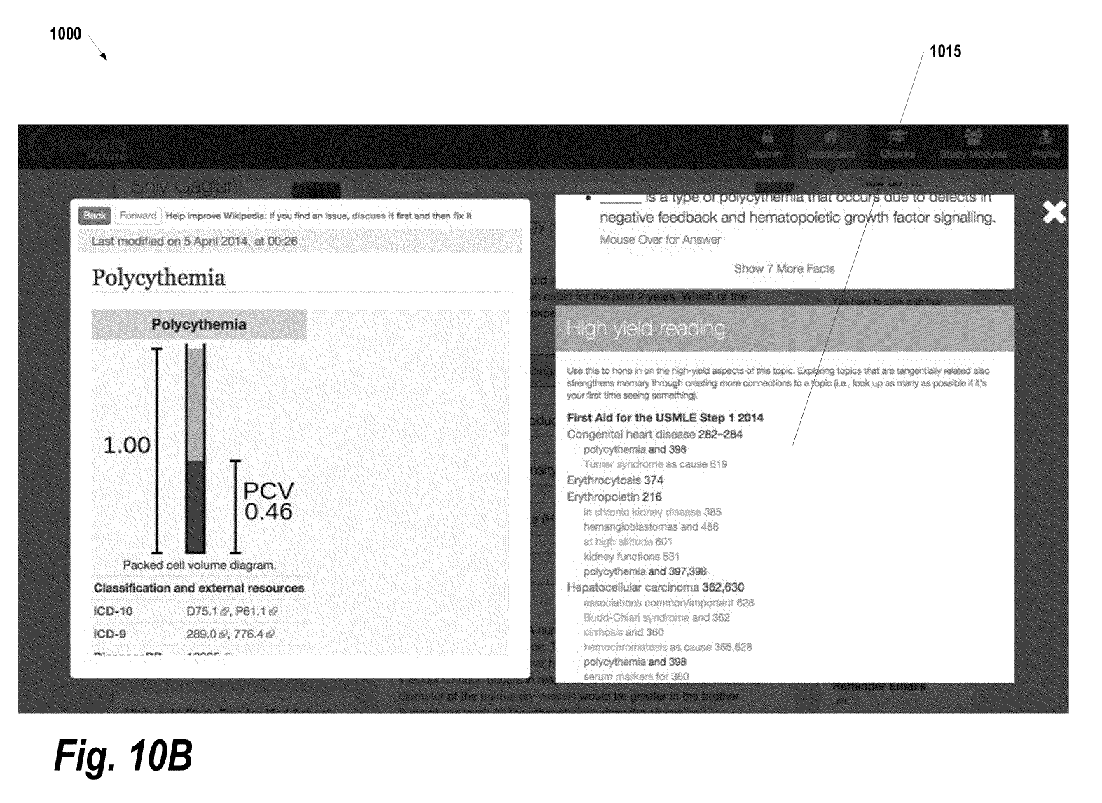

FIG. 10A provides an example web-based interface 1000 illustrating a high-yield study feature, that may be used in some embodiments. In this example, a high yield studying browser comprising a Content Component 1005 and a Review Component 1010 is displayed. The Content Component 1005 in this example presents information from Wikipedia, but other forms of content may alternatively (or additionally) be used. The Review Component 1010 presents relevant questions as “high yield facts” that can also be scheduled for review, for example, via the mobile app. The high yield studying browser in this example is displayed using a lightbox. As is understood in the art, a lightbox displays content by filling the screen, and dimming out the rest of the web page. In other embodiments, as an alternative to a lightbox, other techniques may be used which offer similar visual behavior. For example, in one embodiment, a pop-up window is employed.

FIG. 10B provides an additional view web-based interface 1000 illustrating additional high-yield study features, according to some embodiments. The Knowledge Diffusion Platform is also capable of delivering other reference material, including book index maps. In this example, the user has looked up “polycythemia.” A High Yield Reading Component 1015 then indicates that this concept appears in multiple locations in the “First Aid for the USMLE Step 1 2014” book. There is educational value in simply browsing the index map to draw connections between different topics. Additional visual components (e.g., lightboxes) can be added to the high yield studying feature, including, for example, high yield images, videos, mnemonics, and articles.

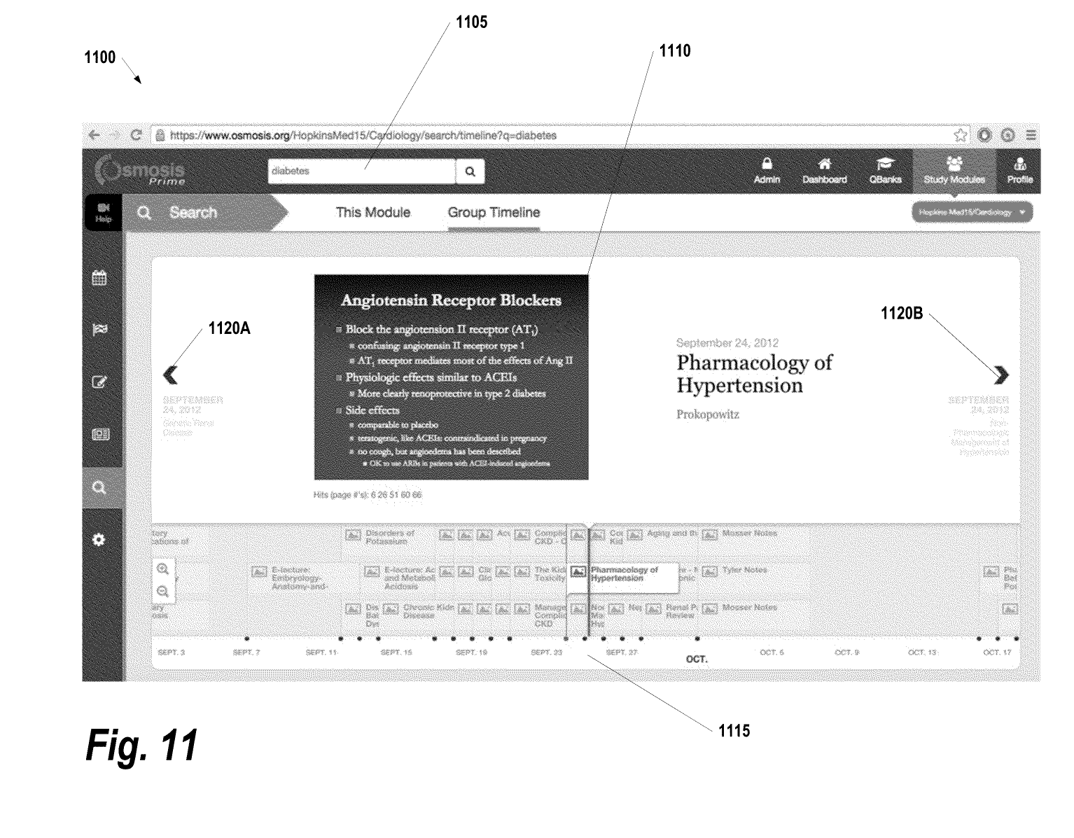

FIG. 11 provides an example web-based interface 1100 illustrating timeline search that may be available in some embodiments. A Query Box 1105 can be used to initiate a search that leverages the extracted text from curricular and non-curricular material as described in FIG. 2. In this example, a search is performed across the curricular material for the term “Diabetes.” A Hyperlinked Thumbnail 1110 shows a document that contains the search term. Pages within a document can be toggled using the hyperlinked numbers below the thumbnail. Clicking on the links will open the document in a new window. Arrow indicators 1120A and 1120B may be used to browse to other documents including the search term. Timeline 1115 appears at the bottom of this interface and shows when the lectures corresponding to the materials took place. Each black dot represents when material containing the search term was presented. Through this web-based interface 1100, users can map a curriculum and develop an appreciation for the relative frequency and coverage of a specific term. This can be beneficial to various types of users. For example, administrators can visualize the curricula they design and answer questions such as how often they cover a particular topic. Faculty members can compare their own lectures to those that came before. For example, a lecturer speaking about tissue perfusion can search for when the hemoglobin dissociation curve was previously covered. Students can use the web-based interface 1100 to access the vast amount of information that they have been taught.

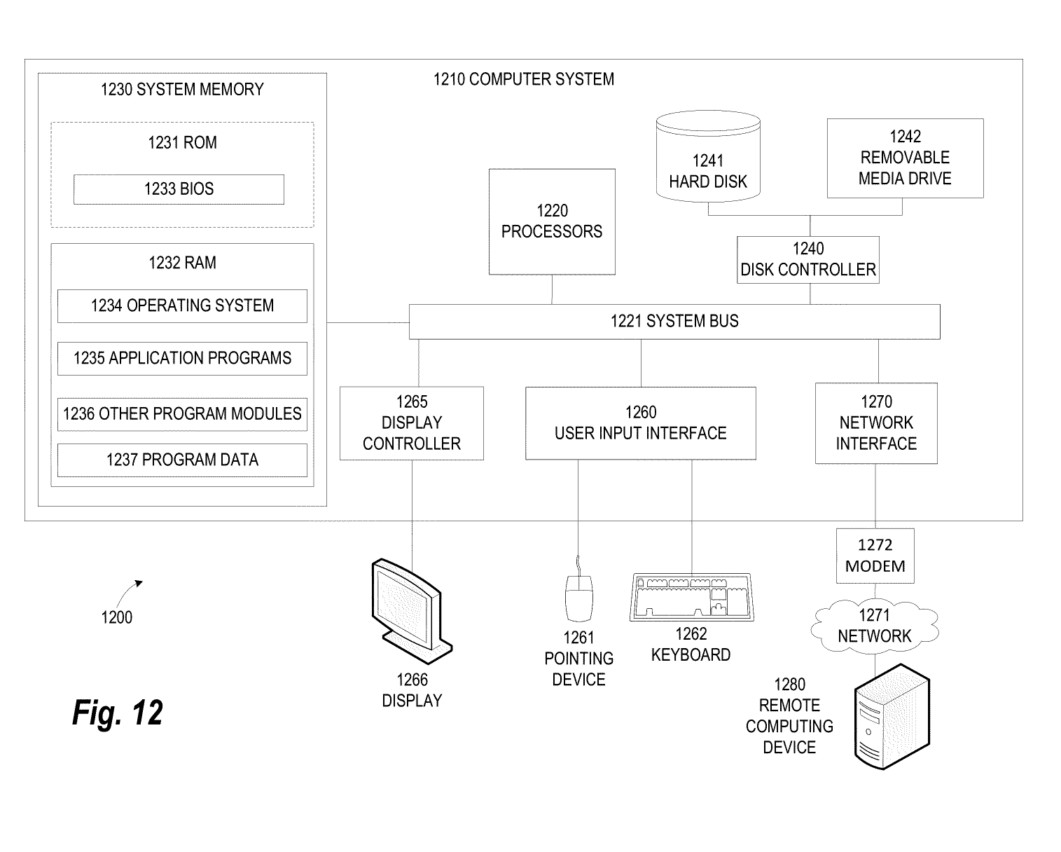

FIG. 12 illustrates an exemplary computing environment 1200 within which embodiments of the invention may be implemented. For example, computing environment 1200 may be used to implement the Knowledge Diffusion Platform 120 shown in FIG. 1. Computers and computing environments, such as computer system 1210 and computing environment 1200, are known to those of skill in the art and thus are described briefly here.

As shown in FIG. 12, the computer system 1210 may include a communication mechanism such as a system bus 1221 or other communication mechanism for communicating information within the computer system 1210. The computer system 1210 further includes one or more processors 1220 coupled with the system bus 1221 for processing the information.

The processors 1220 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 12, the computer system 1210 also includes a system memory 1230 coupled to the system bus 1221 for storing information and instructions to be executed by processors 1220. The system memory 1230 may include computer readable storage media in the form of volatile and/or nonvolatile memory, such as read only memory (ROM) 1231 and/or random access memory (RAM) 1232. The RAM 1232 may include other dynamic storage device(s) (e.g., dynamic RAM, static RAM, and synchronous DRAM). The ROM 1231 may include other static storage device(s) (e.g., programmable ROM, erasable PROM, and electrically erasable PROM). In addition, the system memory 1230 may be used for storing temporary variables or other intermediate information during the execution of instructions by the processors 1220. A basic input/output system 1233 (BIOS) containing the basic routines that help to transfer information between elements within computer system 1210, such as during start-up, may be stored in the ROM 1231. RAM 1232 may contain data and/or program modules that are immediately accessible to and/or presently being operated on by the processors 1220. System memory 1230 may additionally include, for example, operating system 1234, application programs 1235, other program modules 1236 and program data 1237.

The computer system 1210 also includes a disk controller 1240 coupled to the system bus 1221 to control one or more storage devices for storing information and instructions, such as a magnetic hard disk 1241 and a removable media drive 1242 (e.g., floppy disk drive, compact disc drive, tape drive, and/or solid state drive). Storage devices may be added to the computer system 1210 using an appropriate device interface (e.g., a small computer system interface (SCSI), integrated device electronics (IDE), Universal Serial Bus (USB), or FireWire).

The computer system 1210 may also include a display controller 1265 coupled to the system bus 1221 to control a display or monitor 1266, such as a cathode ray tube (CRT) or liquid crystal display (LCD), for displaying information to a computer user. The computer system includes an input interface 1260 and one or more input devices, such as a keyboard 1262 and a pointing device 1261, for interacting with a computer user and providing information to the processors 1220. The pointing device 1261, for example, may be a mouse, a light pen, a trackball, or a pointing stick for communicating direction information and command selections to the processors 1220 and for controlling cursor movement on the display 1266. The display 1266 may provide a touch screen interface that allows input to supplement or replace the communication of direction information and command selections by the pointing device 1261.

The computer system 1210 may perform a portion or all of the processing steps of embodiments of the invention in response to the processors 1220 executing one or more sequences of one or more instructions contained in a memory, such as the system memory 1230. Such instructions may be read into the system memory 1230 from another computer readable medium, such as a magnetic hard disk 1241 or a removable media drive 1242. The magnetic hard disk 1241 may contain one or more datastores and data files used by embodiments of the present invention. Datastore contents and data files may be encrypted to improve security. The processors 1220 may also be employed in a multi-processing arrangement to execute the one or more sequences of instructions contained in system memory 1230. In alternative embodiments, hard-wired circuitry may be used in place of or in combination with software instructions. Thus, embodiments are not limited to any specific combination of hardware circuitry and software.

As stated above, the computer system 1210 may include at least one computer readable medium or memory for holding instructions programmed according to embodiments of the invention and for containing data structures, tables, records, or other data described herein. The term “computer readable medium” as used herein refers to any medium that participates in providing instructions to the processors 1220 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 1241 or removable media drive 1242. Non-limiting examples of volatile media include dynamic memory, such as system memory 1230. Non-limiting examples of transmission media include coaxial cables, copper wire, and fiber optics, including the wires that make up the system bus 1221. Transmission media may also take the form of acoustic or light waves, such as those generated during radio wave and infrared data communications.

The computing environment 1200 may further include the computer system 1210 operating in a networked environment using logical connections to one or more remote computers, such as remote computing device 1280. Remote computing device 1280 may be a personal computer (laptop or desktop), a mobile device, a server, a router, a network PC, a peer device or other common network node, and typically includes many or all of the elements described above relative to computer system 1210. When used in a networking environment, computer system 1210 may include modem 1272 for establishing communications over a network 1271, such as the Internet. Modem 1272 may be connected to system bus 1221 via user network interface 1270, or via another appropriate mechanism.

Network 1271 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1210 and other computers (e.g., remote computing device 1280). The network 1271 may be wired, wireless or a combination thereof. Wired connections may be implemented using Ethernet, Universal Serial Bus (USB), or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1271.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity. Also, while some method steps are described as separate steps for ease of understanding, any such steps should not be construed as necessarily distinct nor order dependent in their performance.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method for generating educational materials for a user, the method comprising:
receiving, by a computer, a user data item representative of educational interests of the user;
extracting, by the computer, a plurality of words from the user data item;
classifying, by the computer, the user data item into a related knowledge domain;
determining, by the computer, a frequency score for each of the plurality of words;
using, by the computer, the frequency score determined for each of the plurality of words to select a plurality of educational material items associated with the related knowledge domain;
determining, by the computer, a similarity score for each of the plurality of educational material items indicative of each respective educational material item's similarity to the user data item;
using, by the computer, the similarity score for each of the plurality of educational material items to select a subset of the plurality of educational material items; and
presenting, by the computer, the subset of the plurality of educational material items in a graphical user interface.

2. The method of claim 1, wherein the user data item comprises curriculum materials related to academic courses in which the user is enrolled.

3. The method of claim 1, wherein the user data item comprises a video and the plurality of words are extracted from the user data item using closed caption information associated with the video.

4. The method of claim 1, further comprising:
prior to extracting the plurality of words from the user data item, tokenizing the plurality of words to group related words as entities.

5. The method of claim 4, wherein the user data item is classified into the related knowledge domain by a process comprising:
selecting a plurality of knowledge domains;
assigning each of the plurality of words to one of the plurality of knowledge domains;
determining a word count for each of the plurality of knowledge domains corresponding to a number of assigned words from the plurality of words; and
designating one knowledge domain having a maximum word count as the related knowledge domain.

6. The method of claim 5, wherein the user data item is presented simultaneously with the plurality of educational material items in the graphical user interface.

7. The method of claim 1, wherein the plurality of educational material items comprise a plurality of questions.

8. The method of claim 7, wherein each of the plurality of questions is presented sequentially in the graphical user interface.

9. The method of claim 8, wherein each respective question is presented with a plurality of graphical input components comprising:
a first set of graphical input components configured to receive user selection of an answer to the respective question; and
a second set of graphical input components configured to receive user selection of a confidence indicator for the respective question.

10. The method of claim 9, wherein the plurality of graphical input components further comprising:
a third set of graphical input components configured to receive user selection of a rating indicator for the respective question.

11. A computer-implemented method for providing educational resources to a user, the method comprising:
receiving user materials indicative of at least one of a user interest or user activity;
identifying, by a computer, one or more relevant terms related to the user materials;
for each of a plurality of supplementary educational resources, calculating, by the computer, a similarity score between the respective supplementary educational resource and the user materials;
automatically identifying, by the computer, one or more recommended supplementary educational resources from the plurality of supplementary educational resources based on the one or more relevant terms and the similarity scores; and
providing the one or more recommended supplementary educational resources to the user.

12. The method of claim 11, wherein the one or more recommended supplementary educational resources comprises a plurality of questions.

13. The method of claim 12, wherein each respective question in the plurality of questions is presented sequentially in a graphical user interface comprising:
the respective question;
a first set of graphical input components configured to receive user selection of an answer to the respective question; and
a second set of graphical input components configured to receive user selection of a confidence indicator for the respective question.

14. The method of claim 13, further comprising:
receiving a plurality of user answer values and a plurality of user confidence values in response to presenting the plurality of questions; and
determining an intuition index for the user based on the plurality of user answer values and the plurality of user confidence values, the intuition index representative of a relationship between confidence of the user and accuracy of the user in answering the plurality of questions.

15. The method of claim 14, further comprising:
presenting educational materials to a plurality of additional users; and
generating a plurality of additional intuition indexes for the plurality of additional users, each respective additional intuition index corresponding to responses provided by a respective additional user in response to presenting educational materials to the respective additional user;
using the intuition index and the plurality of additional intuition indexes to select a group of users; and
providing targeted educational materials to the group of users.

16. The method of claim 11, further comprising:
scheduling delivery of the one or more recommended supplementary educational resources to the user based on a list of upcoming test dates from the user.

17. The method of claim 16, further comprising:
providing delivery of the one or more recommended supplementary educational resources to the user via a mobile phone application.

18. The method of claim 17, further comprising:
sending at least one push notification corresponding to the one or more recommended supplementary educational resources to the user via the mobile phone application.

19. The method of claim 11, wherein the user materials comprise a video and the method further comprises:
identifying time points of the video during which the user activated paused, rewound, or fast-forwarded functionality;
selecting one or more additional educational resources based on the time points; and
providing the one or more additional educational resources to the user.

20. An article of manufacture for generating educational materials for a user, the article of manufacture comprising a non-transitory, tangible computer-readable medium holding computer-executable instructions for performing a method comprising:
receiving a user data item representative of educational interests of the user;
extracting a plurality of words from the user data item;
classifying the user data item into a related knowledge domain;
determining a frequency score for each of the plurality of words;
using the frequency score determined for each of the plurality of words to select a plurality of educational material items associated with the related knowledge domain;
determining a similarity score for each of the plurality of educational material items indicative of each respective educational material item's similarity to the user data item;
using the similarity score for each of the plurality of educational material items to select a subset of the plurality of educational material items; and
presenting the subset of the plurality of educational material items in a graphical user interface.
